(19) United States
(12) Patent Application Publication
(10) Pub. No.: US 2025/0011173 A1
(43) Pub. Date: Jan. 9, 2025

(54) BIOMASS-DERIVED CARBON PARTICLE, AND PREPARATION METHOD AND USE THEREOF

(71) Applicant: Shanghai Jiao Tong University, Shanghai (CN)

(72) Inventors: Jinming LUO, Shanghai (CN); Kaixing FU, Shanghai (CN)

(73) Assignee: Shanghai Jiao Tong University, Shanghai (CN)

(21) Appl. No.: 18/459,781

(22) Filed: Sep. 1, 2023

(30) Foreign Application Priority Data
Jul. 3, 2023 (CN) 2023107976536

(51) Int. Cl. C01B 32/05

(52) U.S. Cl. CPC C01B 32/05; C01P 2004/62

(57) ABSTRACT

Provided are a biomass-derived carbon particle, and a preparation method and use thereof. The biomass-derived carbon particle includes a non-graphitized biochar and a graphitized biochar; where the non-graphitized biochar and the graphitized biochar each have an oxygen-containing functional group; and the oxygen-containing functional group includes one selected from the group consisting of hydroxyl group, phenolic hydroxyl group, carbonyl group, and ether group.

### CROSS REFERENCE TO RELATED APPLICATION

This patent application claims the benefit and priority of Chinese Patent Application No. 2023107976536 filed with the China National Intellectual Property Administration on Jul. 3, 2023, the disclosure of which is incorporated by reference herein in its entirety as part of the present application.

### TECHNICAL FIELD

The present disclosure belongs to the technical field of preparation of functional materials, and in particular relates to a biomass-derived carbon particle, and a preparation method and use thereof.

### BACKGROUND

Gold is widely used in various industries due to its excellent corrosion resistance and high conductivity. However, a conflict between limited mine gold resources and increasing gold demand has gradually made gold an extremely scarce metal resource. In fact, recovering gold from electronic wastes such as printed circuit boards and CPUs is more economically and ecologically efficient than traditional ore mining. Therefore, it is of great significance for the treatment and recycling of gold-containing solid waste to develop an efficient and cheap adsorbent for the recovery of gold ions in electronic waste.

Currently, a variety of gold ion adsorbents have been reported in the literature, including metal-organic frameworks (MOFs), covalent organic frameworks (COFs), and molybdenum disulfide. However, these gold ion adsorbents are generally limited in two aspects. Firstly, the gold ion is simply adsorbed, and subsequently desorbed and reduced to obtain a high-purity elemental gold. Secondly, the gold ion reduced was deposited onto adsorbent surface as elemental gold, it is however difficult for subsequent separation of adsorbents (i.e., biochar) and the elemental gold as the biochar prepared according to the existing literatures is in the form of powder, which increases the complexity during use and the difficulty of separation and recovery.

### SUMMARY

An object of the present disclosure is to provide a biomass-derived carbon particle, and a preparation method and use thereof. In the present disclosure, the biomass-derived carbon particle makes it possible to reduce a gold ion into an elemental gold which could be easily separated from the biomass-derived carbon particle.

To achieve the above object, the present disclosure provides the following technical solutions:

Provided is a biomass-derived carbon particle, including a non-graphitized biochar and a graphitized biochar; where
the non-graphitized biochar and the graphitized biochar each have an oxygen-containing functional group; and
the oxygen-containing functional group includes one selected from the group consisting of hydroxyl group, phenolic hydroxyl group, carbonyl group, and ether group.

In some embodiments, the biomass-derived carbon particle has a particle size of 0.5 mm to 1 mm.

Also provided is a method for preparing the biomass-derived carbon particle described above, including the following steps:
(1) adding a sodium alginate solution dropwise into a calcium chloride solution to obtain a gel ball, aging the gel ball to obtain an aged gel ball, and freeze-drying the aged gel ball to obtain a calcium alginate xerogel ball; and
(2) subjecting the calcium alginate xerogel ball to pre-carbonization, carbonization, and acid leaching sequentially to obtain the biomass-derived carbon particle; where the pre-carbonization and the carbonization each are conducted in an inert atmosphere.

In some embodiments, the freeze-drying is conducted at a vacuum degree of 1 Pa to 10 Pa and a cold trap temperature of −75° C. to −60° C. for 12 h to 72 h.

In some embodiments, the pre-carbonization is conducted at a temperature of 250° C. to 350° C. for 1 h to 5 h.

In some embodiments, the carbonization is conducted at a temperature of 400° C. to 900° C. for 1 h to 5 h.

In some embodiments, the sodium alginate solution has a concentration of 0.5 wt % to 3 wt %; and the calcium chloride solution has a concentration of 0.5 wt % to 4 wt %.

In some embodiments, the acid leaching is conducted for 1 h to 24 h; and
the acid leaching is conducted with an acid, the acid including one or two selected from the group consisting of hydrochloric acid and sulfuric acid, and having a concentration of 0.01 mol/L to 0.5 mol/L.

In some embodiments, the aging is conducted for 6 h to 36 h.

Also provided is use of the biomass-derived carbon particle described above or the biomass-derived carbon particle prepared by the method described above in adsorption of gold ions.

The present disclosure provides a biomass-derived carbon particle, including a non-graphitized biochar and a graphitized biochar: where the non-graphitized biochar and the graphitized biochar each have an oxygen-containing functional group; and the oxygen-containing functional group includes one selected from the group consisting of hydroxyl group, phenolic hydroxyl group, carbonyl group, and ether group. In the present disclosure, the biomass-derived carbon particle has a certain graphite phase composition. Conjugated π bonds formed by p orbitals of carbon atoms on the graphite structure have a large number of free electrons, which endow the biomass-derived carbon particle with certain electron transfer capabilities and reduction properties. Meanwhile, the biomass-derived carbon particle according to the present disclosure contains a large number of oxygen-containing groups (such as carbonyl group and phenolic hydroxyl group) in its structure. These redox-active oxygen-containing groups could not only serve as adsorption sites for Au ions, but also be used for direct reduction of Au ions. Compared with other metal ions, gold ions show a higher redox potential (E°_{Au(III)/Au}=+1.498 V (Au³⁺)/+1.002 V (AuCl⁴⁻)). Based on the above reasons, the biomass-derived carbon particle of the present disclosure has extremely-high gold selective reduction and recovery capabilities, stable properties, and strong working pH tolerance, and makes it possible to realize rapid and high-capacity recovery of the gold ion in water bodies with a high recovery rate of the gold ion. Meanwhile, the biomass-derived carbon particle could also reduce the gold ion into the elemental gold which could be easily separated from the biomass-derived carbon particle.

The present disclosure further provides a method for preparing the biomass-derived carbon particle. In the present disclosure, sodium alginate with a low cost could be quickly cross-linked with calcium ions to prepare a gel ball with a uniform size through continuous dropwise addition; and the gel ball is subjected to carbonization and pyrolysis under an inert atmosphere to obtain the biomass-derived carbon particle. The method of the present disclosure could be performed without any poisonous, harmful, or costly reagents, shows environmental friendliness and low cost, and makes it possible to realize continuous production.

The present disclosure further provides use of the biomass-derived carbon particle or the biomass-derived carbon particle prepared by the method described above in adsorption of gold ions. In the present disclosure, the biomass-derived carbon particle could be used for direct and efficient adsorption and reduction recovery of gold ions in electronic wastes, such that a high-purity elemental gold could be directly obtained and easily recovered. The high-purity separation of the elemental gold could be achieved through a combination of calcination and acid leaching. The method of the present disclosure shows strong operability, desirable economic and ecological benefits.

### BRIEF DESCRIPTION OF THE DRAWINGS

To describe the technical solutions in embodiments of the present disclosure or in prior arts more clearly, accompanying drawings required for the embodiments are briefly described below. Apparently, the accompanying drawings in the following description show merely some embodiments of the present disclosure, and other accompanying drawings could be obtained by those skilled in the art from these accompanying drawings without creative efforts.

FIG. 1A shows an appearance diagram of the biomass-derived carbon particle prepared in Example 1 of the present disclosure.

FIG. 1B and FIG. 1C show scanning electron microscopy (SEM) images of the biomass-derived carbon particle prepared in Example 1 of the present disclosure.

FIG. 2 shows an infrared spectrogram of the biomass-derived carbon particle prepared in Example 1 of the present disclosure.

FIG. 3 shows a Raman spectrogram of the biomass-derived carbon particle prepared in Example 1 of the present disclosure.

FIG. 4 shows an X-ray diffraction (XRD) spectrum of the biomass-derived carbon particle prepared in Example 1 of the present disclosure.

FIG. 5A shows a kinetic curve for adsorption of Au (III) by the biomass-derived carbon particle prepared in Example 1 of the present disclosure.

FIG. 5B shows an adsorption isotherm curve for adsorption of Au (III) by the biomass-derived carbon particle prepared in Example 1 of the present disclosure.

FIG. 6 shows a bar graph of an adsorption capacity of the biomass-derived carbon particle prepared in Example 1 of the present disclosure for adsorption of Au (III) under different acid-base conditions.

FIG. 7A shows a diagram of an influence of coexisting cations in a solution on the adsorption of Au (III) by the biomass-derived carbon particle prepared in Example 1.

FIG. 7B shows a diagram of a partition coefficient K_{d} of the biomass-derived carbon particle prepared in Example 1 for the adsorption of different metal ions.

FIG. 8 shows a diagram of a recovery ratio of Au (III) in different leachate systems of the biomass-derived carbon particle prepared in Example 1 of the present disclosure.

### DETAILED DESCRIPTION OF THE EMBODIMENTS

The present disclosure provides a biomass-derived carbon particle, including a non-graphitized biochar and a graphitized biochar; where
the non-graphitized biochar and the graphitized biochar each have an oxygen-containing functional group; and
the oxygen-containing functional group is selected from the group consisting of hydroxyl group, phenolic hydroxyl group, carbonyl group, and ether group.

In some embodiments, the biomass-derived carbon particle has a particle size of 0.5 mm to 1 mm, and preferably 0.6 mm to 0.8 mm.

The present disclosure further provides a method for preparing the biomass-derived carbon particle described above, including the following steps:
(1) adding a sodium alginate solution dropwise into a calcium chloride solution to obtain a gel ball, aging the gel ball to obtain an aged gel ball, and freeze-drying the aged gel ball to obtain a calcium alginate xerogel ball; and
(2) subjecting the calcium alginate xerogel ball to pre-carbonization, carbonization, and acid leaching sequentially to obtain the biomass-derived carbon particle; where
the pre-carbonization and the carbonization each are conducted in an inert atmosphere.

In the present disclosure, a sodium alginate solution is added dropwise into a calcium chloride solution to obtain a gel ball, the gel ball is aged to obtain an aged gel ball, and the aged gel ball is freeze-dried to obtain a calcium alginate xerogel ball. In some embodiments, the sodium alginate solution has a concentration of 0.5 wt % to 3 wt %, preferably 1 wt % to 2.5 wt %, and more preferably 1.5 wt % to 2 wt %.

In some embodiments, the sodium alginate solution is prepared by a process including: mixing sodium alginate and a solvent to obtain the sodium alginate solution. In some embodiments, the sodium alginate is food-grade sodium alginate or analytical sodium alginate. In some embodiments, the solvent of the sodium alginate solution is water, and the water is tap water or deionized water.

In some embodiments, mixing sodium alginate and the solvent is performed as follows: slowly adding the sodium alginate into the solvent under magnetic stirring. In some embodiments, the sodium alginate is added at a rate of 0.2 g/min to 2 g/min, and preferably 0.5 g/min to 1 g/min.

In some embodiments, the calcium chloride solution has a concentration of 0.5 wt % to 4 wt %, preferably 1 wt % to 3 wt %, and more preferably 1.5 wt % to 2.5 wt %. In some embodiments, a solvent of the calcium chloride solution is water, and the water is tap water or deionized water.

In some embodiments, the calcium chloride solution is prepared by a process including: mixing calcium chloride and the solvent of the calcium chloride solution to obtain the calcium chloride solution. In some embodiments, the calcium chloride is technical-grade calcium chloride or analytical calcium chloride. In some embodiments, the solvent of the calcium chloride solution is water, and the water is tap water or deionized water.

In some embodiments, adding the sodium alginate solution dropwise into the calcium chloride solution is performed by an assisted peristaltic pump. In some embodiments, the sodium alginate solution is added by the peristaltic pump at a flow rate of 0.5 mL/min to 10 mL/min, preferably 1 mL/min to 8 mL/min, and more preferably 3 mL/min to 6 mL/min.

In some embodiments, the aging is conducted for 6 h to 36 h, preferably 10 h to 20 h, and more preferably 14 h to 16 h. In some embodiments, the aging is conducted under stirring; and the stirring is conducted at a rate of 200 r/min to 800 r/min, and preferably 400 r/min to 600 r/min.

In some embodiments, after the aging, the method further includes: washing an obtained aged resultant with water and then draining the surface moisture of the obtained aged resultant. In some embodiments, the washing with water is conducted 1 to 5 times, and preferably 3 to 5 times.

In some embodiments, the freeze-drying is conducted at a vacuum degree of 1 Pa to 10 Pa, preferably 3 Pa to 8 Pa, and more preferably 5 Pa to 6 Pa. In some embodiments, the freeze-drying is conducted at a cold trap temperature of −75° C. to −60° C., preferably −70° C. to −65° C., and more preferably −68° C. to −66° C. In some embodiments, the freeze-drying is conducted for 12 h to 72 h, preferably 30 h to 42 h, and more preferably 36 h to 40 h. In some embodiments, the freeze-drying is conducted by a freeze dryer.

After the calcium alginate xerogel ball is obtained, the calcium alginate xerogel ball is subjected to pre-carbonization, carbonization, and acid leaching sequentially to obtain the biomass-derived carbon particle. In some embodiments, the pre-carbonization is conducted at a temperature of 250° C. to 350° C., preferably 270° C. to 320° C., and more preferably 290° C. to 310° C. In some embodiments, the pre-carbonization is conducted for 1 h to 5 h, preferably 2 h to 4 h, and more preferably 3 h. In some embodiments, the pre-carbonization is conducted in an inert atmosphere, and the inert atmosphere is argon or nitrogen. In some embodiments, the pre-carbonization is conducted in a tubular furnace.

In some embodiments, the carbonization is conducted at a temperature of 400° C. to 900° C., preferably 500° C. to 800° C., and more preferably 600° C. to 700° C. In some embodiments, the carbonization is conducted for 1 h to 5 h, preferably 2 h to 4 h, and more preferably 3 h. In some embodiments, the carbonization is conducted in an inert atmosphere, and the inert atmosphere is argon or nitrogen. In some embodiments, the carbonization is conducted in a tubular furnace. The method of the present disclosure has mild conditions and high safety.

In some embodiments, the acid leaching is conducted for 1 h to 24 h, preferably 4 h to 12 h, and more preferably 6 h to 7 h. In some embodiments, an acid for the acid leaching includes one or two of hydrochloric acid and sulfuric acid, and preferably the hydrochloric acid. In some embodiments, the acid for the acid leaching has a concentration of 0.01 mol/L to 0.5 mol/L, preferably 0.1 mol/L to 0.4 mol/L, and more preferably 0.2 mol/L to 0.3 mol/L. In the present disclosure, calcium carbonate components inside a carbonized resultant obtained by the carbonization could be removed by the acid leaching, obtaining the biomass-derived carbon particle.

After the acid leaching, an acid leaching resultant is obtained. The method further includes: drying the acid leaching resultant. In some embodiments, the drying is conducted at a temperature of 40° C. to 120° C., and preferably 60° C. to 100° C. In some embodiments, the drying is conducted for 4 h to 48 h, and preferably 12 h to 36 h.

The present disclosure further provides use of the biomass-derived carbon particle or the biomass-derived carbon particle prepared by the method described above in adsorption of gold ions.

In some embodiments, the use of the biomass-derived carbon particle in adsorption of gold ions includes the following steps:
mixing the biomass-derived carbon particle and a water body to be treated to allow adsorption to obtain an adsorbed biomass-derived carbon particle, taking out the adsorbed biomass-derived carbon particle, and separating an elemental gold from the adsorbed biomass-derived carbon particle.

In some embodiments, a ratio of the mass of the biomass-derived carbon particle to the volume of the water body to be treated is in a range of (0.2-2) g:1 L, and preferably (0.5-1) g:1 L.

In some embodiments, the mixing is conducted by shaking, and the shaking is conducted on a constant-temperature shaker. In some embodiments, the shaking is conducted at a temperature of 15° C. to 35° C., and preferably 25° C. In some embodiments, the shaking is conducted at a frequency of 120 rpm to 240 rpm, and preferably 180 rpm.

In some embodiments, the adsorption is conducted for 0.5 h to 12 h, and preferably 1 h to 3 h.

In some embodiments, separating the elemental gold from the adsorbed biomass-derived carbon particle is performed as follows: subjecting the adsorbed biomass-derived carbon particle to first water washing and calcination in sequence to obtain a calcined resultant, and subjecting the calcined resultant to acid leaching, shaking, and second water washing in sequence to obtain the elemental gold.

In some embodiments, the adsorbed biomass-derived carbon particle has a single separation capacity for the elemental gold of 0.5 g to 10 g, and preferably 1 g to 3 g. In some embodiments, the first water washing is conducted with deionized water, and the first water washing is conducted 1 to 5 times, and preferably 2 to 3 times.

In some embodiments, the calcination is conducted at a temperature of 700° C. to 1,000° C., and preferably 800° C. In some embodiments, the calcination is conducted for 1 h to 5 h. and preferably 2 h to 3 h. In some embodiments, the calcination is conducted in a muffle furnace.

In some embodiments, the acid leaching is conducted with concentrated hydrochloric acid. In some embodiments, the concentrated hydrochloric acid has a molarity of 6 mol/L to 12 mol/L, and preferably 10 mol/L to 12 mol/L. In some embodiments, a ratio of the mass of the calcined resultant to the volume of the concentrated hydrochloric acid is in a range of (5-50) g:1 L, and preferably (15-45) g:1 L.

In some embodiments, the shaking is conducted for 12 h to 48 h, and preferably 16 h to 30 h. In some embodiments, the shaking is conducted in a constant-temperature shaker.

In some embodiments, the second water washing is conducted with deionized water, and the second water washing is conducted 2 to 6 times, and preferably 4 to 5 times.

In order to further illustrate the present disclosure, the technical solutions provided by the present disclosure are described in detail below in connection with accompanying drawings and examples, but these examples should not be understood as limiting the claimed scope of the present disclosure.

### Example 1

### Preparation of a Biomass-Derived Carbon Particle BC700:

(1) 2 L of deionized water was added into a beaker, and 20.0 g of sodium alginate was slowly added into the deionized water, and dissolved by stirring at 1,000 rpm to obtain a sodium alginate solution with a mass fraction of 1 wt %. The sodium alginate solution was slowly added dropwise into a CaCl₂) solution with a mass fraction of 2 wt % by a continuous peristaltic pump, aged for 12 h, washed with water 3 times, drained to remove surface moisture, and freeze-dried in a freeze-dryer for 36 h to obtain a calcium alginate xerogel ball.

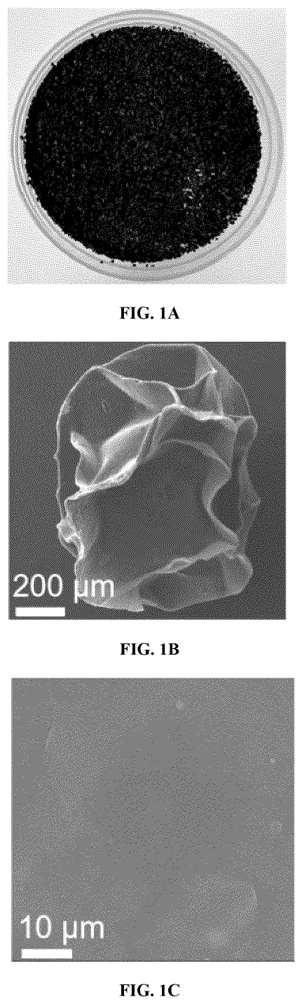

(2) Under the protection of argon, the calcium alginate xerogel ball was subjected to pre-carbonization in a tubular furnace at 300° C. for 2 h, and then heated to 700° C. to allow carbonization for 2 h to obtain a carbonized particle. The carbonized particle was immersed in a 0.1 mol/L hydrochloric acid solution for 6 h to remove internal calcium carbonate components. The obtained resultant was dried in an oven at 60° C. for 6 h to obtain the biomass-derived carbon particle BC700, with a structure shown in FIG. 1A to FIG. 1C. As shown in FIG. 1A to FIG. 1C, the BC700 prepared in this example has a millimeter-scale granular structure, with a smooth and flat surface and without obvious porous channels.

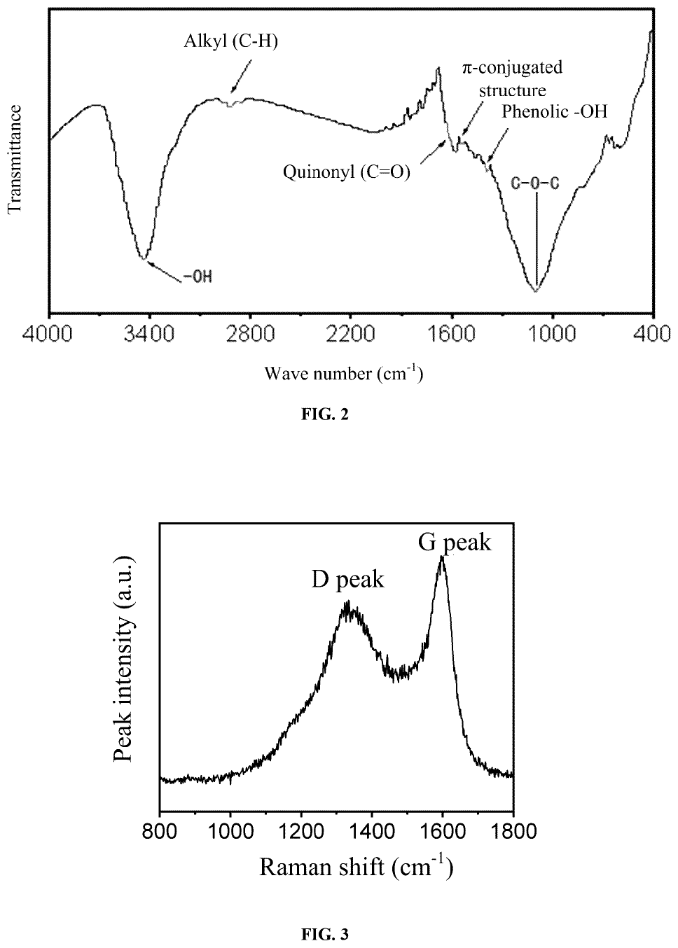

An infrared spectrum test was conducted on the biomass-derived carbon particle prepared in this example, and the results are shown in FIG. 2. As shown in FIG. 2, the biomass-derived carbon particle BC700 has a variety of oxygen-containing groups, including hydroxyl (—OH) vibration peak at 3,452 cm⁻¹, an alkane (C—H) vibration peak at 2,885 cm⁻¹, a carbonyl (C═O) vibration peak at 1,620 cm⁻¹, phenolic hydroxyl (Phenolic-OH) vibration peak at 1,389 cm⁻¹, and ether bond (C—O—C) vibration peak at 1,100 cm⁻¹. A characteristic peak located at 1,550 cm⁻¹ confirms that the BC700 has a π-conjugated graphite structure, and free electrons existing in this structure could make the biomass-derived carbon particle have an excellent conductivity.

The Raman spectrum analysis was conducted on the biomass-derived carbon particle prepared in this example, and the results are shown in FIG. 3. As shown in FIG. 3, there are a D peak at 1.344 cm⁻¹ and a G peak at 1,597 cm⁻¹, which are attributed to a defect peak showing the degree of structural disorder and a graphite peak showing the degree of graphitization, respectively. A peak intensity ratio of the D peak to the G peak is 0.77, indicating that there is a certain degree of defect structures, which is beneficial to improve the conductivity of the biomass-derived carbon particle and promote electron transfer for gold reduction.

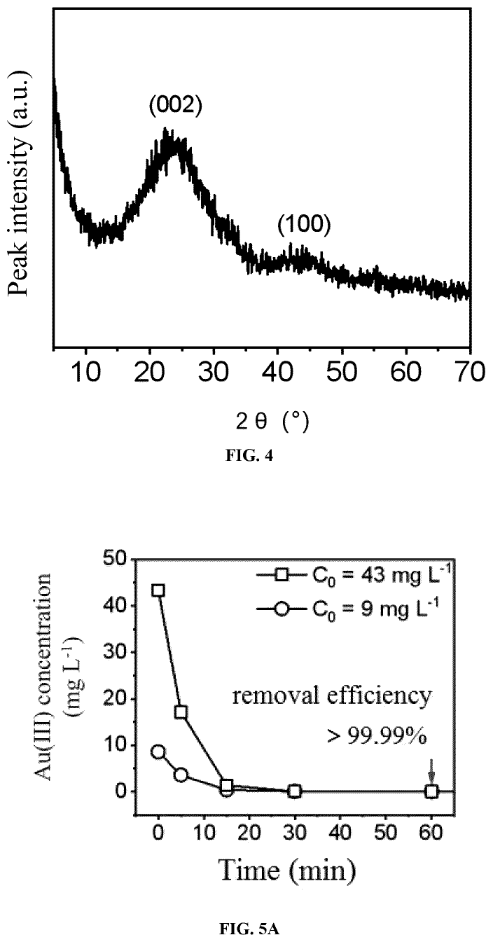

The XRD analysis was conducted on the biomass-derived carbon particle prepared in this example, and the results are shown in FIG. 4. According to FIG. 4, a (002) peak at 23.9° and a (100) peak at 44.0° confirm that the biomass-derived carbon particle BC700 has a graphite structure.

### Example 2

Preparation of a biomass-derived carbon particle BC500:

The biomass-derived carbon particle BC500 was prepared by a method the same as that in Example 1, except that the carbonization was conducted at 500° C. instead of 700° C., while other steps remained unchanged to obtain the biomass-derived carbon particle BC500.

### Example 3

### Preparation of a Biomass-Derived Carbon Particle BC600:

The biomass-derived carbon particle BC600 was prepared by a method the same as that in Example 1, except that the carbonization was conducted at 600° C. instead of 700° C., while other steps remained unchanged to obtain the biomass-derived carbon particle BC600.

### Example 4

### Preparation of a Biomass-Derived Carbon Particle BC800:

The biomass-derived carbon particle BC800 was prepared by a method the same as that in Example 1, except that the carbonization was conducted at 800° C. instead of 700° C., while other steps remained unchanged to obtain the biomass-derived carbon particle BC800.

### Comparative Example 1

In this example, a preparation method was the same as that in Example 1, except that the preparation of the calcium alginate xerogel ball was omitted, and the calcium alginate xerogel ball was replaced with a sodium alginate powder to allow the pre-carbonization, while other steps remained unchanged to obtain sodium alginate 700.

### Comparative Example 2

In this example, a preparation method was the same as that in Example 1, except that the immersing in a hydrochloric acid solution and the drying in an oven were omitted, while other steps remained unchanged to obtain sodium alginate CA700.

### Comparative Example 3

In this example, a preparation method was the same as that in Example 1, except that the preparation of the calcium alginate xerogel ball was replaced by the preparation of a chitosan xerogel ball, while other steps remained unchanged. A specific process was performed as follows:

(1) 2 L of deionized water was added into a beaker, acetic acid was added to form a 2 v/v % acetic acid solution, and 20.0 g of chitosan was slowly added into the acetic acid solution and dissolved by stirring at 1,000 rpm to obtain a chitosan solution with a mass fraction of 1 wt %. The chitosan solution was slowly added dropwise into a NaOH solution of 0.5 mol/L by a continuous peristaltic pump, aged for 12 h, washed with water 3 times, drained to remove surface moisture, and freeze-dried in a freeze-dryer for 36 h to obtain a chitosan xerogel ball.

(2) Under the protection of argon, the chitosan xerogel ball was subjected to pre-carbonization in a tubular furnace at 300° C. for 2 h, and then heated to 700° C. to allow carbonization for 2 h to obtain a chitosan-derived carbon particle CS700.

### Test Example 1

Determination of adsorption kinetics: 0.1 g of the biomass-derived carbon particle BC700 prepared in Example 1 was added to a 100 mL sample bottle filled with an Au (III) solution at a certain concentration (9.8 mg/L and 43 mg/L). The sample bottle was shaken in a constant-temperature shaker at 180 rpm and 25° C. A sample was taken at regular intervals, the sample was passed through a 0.22 μm hydrophilic filter membrane, and a concentration of Au (III) in a resulting filtrate was determined. The results are shown in FIG. 5A.

As shown in FIG. 5A, when the initial concentration is 9 mg/L, the adsorption reaches equilibrium in about 15 min. When the initial concentration is 43 mg/L, the adsorption reaches equilibrium in about 30 min. After 60 min of adsorption, the biomass-derived carbon particle BC700 has a recovery rate of 99.99% for Au (III) in the solution.

### Test Example 2

Adsorption isotherm determination: 10 mL of Au (III) solutions with concentrations of 10, 100, 300, 500, 750, and 1,000 mg/L were separately prepared in 25 mL sample bottles. 3 mg of the biomass-derived carbon particle BC700 of Example 1 was added to each of the sample bottles. The sample bottles each were shaken in a constant-temperature shaker at 180 rpm and 25° C. A sample was taken after 6 h of reaction, the sample was passed through a 0.22 μm hydrophilic filter membrane, and a concentration of Au (III) in a resulting filtrate was determined. The results are shown in FIG. 5B.

As shown in FIG. 5B, by fitting an adsorption isotherm curve with a Langmuir isotherm model, it can be determined that the biomass-derived carbon particle BC700 has a maximum theoretical adsorption capacity of 1,524.8 mg g⁻¹ for adsorbing the Au (III).

### Test Example 3

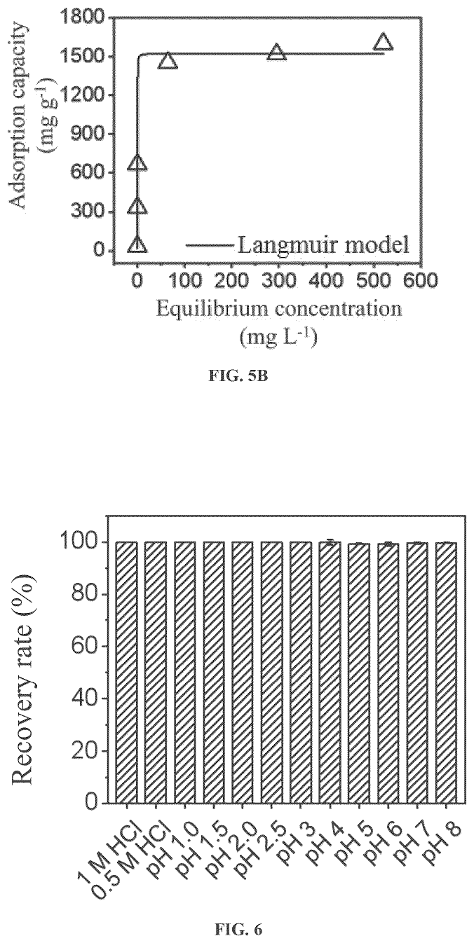

Determination of an influence of solution acidity and alkalinity: 10 mL of hydrochloric acid solutions with concentrations of 1 mol/L and 0.5 mol/L, and aqueous solutions with pH values of 1.0, 1.5, 2.0, 2.5, 3.0, 4.0, 5.0, 6.0, 7.0, and 8.0 were separately prepared in 25 mL sample bottles. 0.1 mL of 1,000 mg/L Au (III) solution was separately added to the above sample bottles, shaken well and added with 3 mg of the biomass-derived carbon particle BC700 of Example 1. The sample bottles each were shaken in a constant-temperature shaker at 180 rpm and 25° C. A sample was taken after 6 h of reaction, the sample was passed through a 0.22 μm hydrophilic filter membrane, and a concentration of Au (III) in a resulting filtrate was determined. The results are shown in FIG. 6.

As shown in FIG. 6, the biomass-derived carbon particle BC700 exhibits extremely strong working pH tolerance, and has an adsorption recovery rate for Au (III) of approximately 100.0% at a pH value of 1.0 to 8.0. Even under extremely strong acidic conditions (0.5 mol/L and 1.0 mol/L hydrochloric acid solutions), the recovery rate of Au (III) is still close to 100.0%, indicating that the biomass-derived carbon particle BC700 shows strong applicability under complex conditions.

### Test Example 4

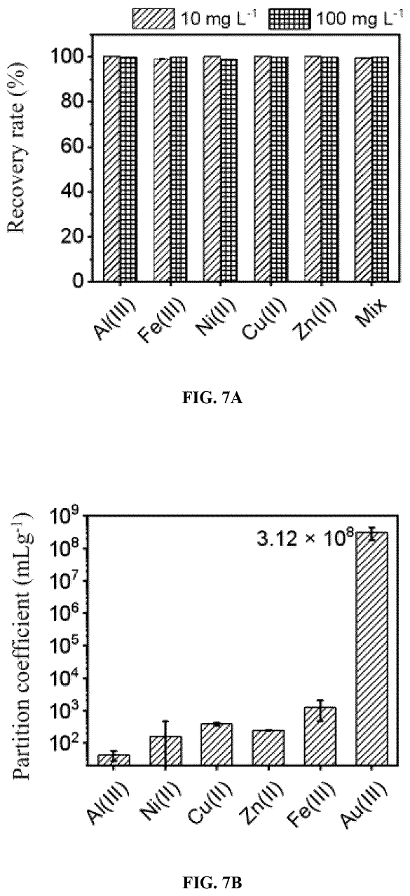

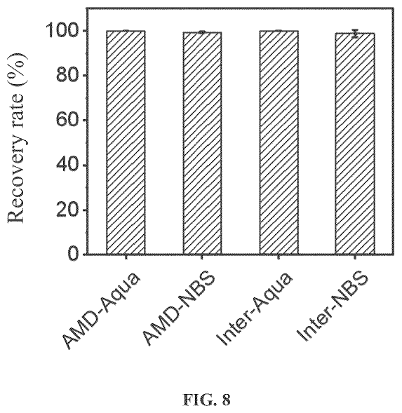

Influence of coexisting cations and determination of adsorption selectivity: Al (III) solutions, Fe (III) solutions, Ni (II) solutions, Cu (II) solutions, and Zn (II) solutions each with concentrations of 10 mg/L and 100 mg/L, and mixed solutions of the above ions (the concentration of each ion in the mixed solutions was 10 mg/L and 100 mg/L, respectively) were prepared separately in 25 mL sample bottles. 0.1 mL of 1,000 mg/L Au (III) solution was separately added to the above sample bottles, shaken well and added with 3 mg of the biomass-derived carbon particle BC700 of Example 1. The sample bottles each were shaken in a constant-temperature shaker at 180 rpm and 25° C. A sample was taken after 6 h of reaction, the sample was passed through a 0.22 μm hydrophilic filter membrane, and a concentration of Au (III) in a resulting filtrate was determined. The results are shown in FIG. 7A and FIG. 7B.

As shown in FIG. 7A and FIG. 7B, the biomass-derived carbon particle BC700 has extremely strong resistance to the interference of coexisting cations. The biomass-derived carbon particle BC700 has a K_{d} value of 3.12×10⁸ mL g⁻¹ for adsorbing Au (III), which is 5 to 7 orders of magnitude higher than the K_{d} values of other metal ions, confirming an ultrahigh selective adsorption capacity of the biomass-derived carbon particle BC700 for Au (III).

### Test Example 5

Determination of a recovery rate in actual CPU leaching solutions: AMD and Inter graphics cards were separately treated with aqua regia (Aqua) and N-bromosuccinimide (NBS)-pyridine systems, respectively, to obtain leachates under four different conditions. These leachates were marked as AMD-Aqua, AMD-NBS, Inter-Aqua, and Inter-NBS, respectively, where the AMD-Aqua was obtained by diluting an original leachate 10 times with water and adjusting a pH value to 1.5. 10 mL each of the four leachates were added to sample bottles, and 10 mg of the biomass-derived carbon particle BC700 of Example 1 was added separately in the sample bottles. The sample bottles each were shaken in a constant-temperature shaker at 180 rpm and 25° C. A sample was taken after 12 h of reaction, the sample was passed through a 0.22 μm hydrophilic filter membrane, and a concentration of Au (III) in a resulting filtrate was determined. The results are shown in FIG. 8.

As shown in FIG. 8, the recovery rate of the biomass-derived carbon particle BC700 to the Au (III) in the 4 leachate systems could reach 99.9%, indicating that the biomass-derived carbon particle BC700 has strong practical application potential and is an excellent gold adsorbent.

### Use Example 1

3 g each of adsorbed biomass-derived carbon particles in Test Examples 1 to 5 was washed 5 times with deionized water, and calcined in a muffle furnace at 800° C. for 3 h. An obtained calcined resultant was immersed in concentrated hydrochloric acid with a HCl concentration of 12 mol/L (a feed ratio of the calcined resultant and the concentrated hydrochloric acid was 25 g:1 L), and then shaken in a constant-temperature shaker for 30 h. A resulting leached product was washed 5 times with deionized water to obtain an elemental gold.

It can be known from the above examples that the biomass-derived carbon particle provided by the present disclosure has an extremely high ability to selectively reduce and recover gold, and makes it possible to realize rapid and high-capacity recovery of gold ions in water bodies. The biomass-derived carbon particle of the present disclosure shows high gold ion recovery rate and strong working pH tolerance.

Although the present disclosure is described in detail in conjunction with the foregoing embodiments, they are only a part of, not all of, the embodiments of the present disclosure. Other embodiments can be obtained based on these embodiments without creative efforts, and all of these embodiments shall fall within the scope of the present disclosure.

What is claimed is:

1. A biomass-derived carbon particle, comprising a non-graphitized biochar and a graphitized biochar; wherein
the non-graphitized biochar and the graphitized biochar each have an oxygen-containing functional group; and
the oxygen-containing functional group comprises one selected from the group consisting of hydroxyl group, phenolic hydroxyl group, carbonyl group, and ether group.

2. The biomass-derived carbon particle of claim 1, wherein the biomass-derived carbon particle has a particle size of 0.5 mm to 1 mm.

3. A method for preparing the biomass-derived carbon particle of claim 1, comprising the following steps:
(1) adding a sodium alginate solution dropwise into a calcium chloride solution to obtain a gel ball, aging the gel ball to obtain an aged gel ball, and freeze-drying the aged gel ball to obtain a calcium alginate xerogel ball; and
(2) subjecting the calcium alginate xerogel ball to pre-carbonization, carbonization, and acid leaching sequentially to obtain the biomass-derived carbon particle; wherein
the pre-carbonization and the carbonization each are conducted in an inert atmosphere.

4. The method of claim 3, wherein the freeze-drying is conducted at a vacuum degree of 1 Pa to 10 Pa and a cold trap temperature of −75° C. to −60° C. for 12 h to 72 h.

5. The method of claim 3, wherein the pre-carbonization is conducted at a temperature of 250° C. to 350° C. for 1 h to 5 h.

6. The method of claim 3, wherein the carbonization is conducted at a temperature of 400° C. to 900° C. for 1 h to 5 h.

7. The method of claim 3, wherein the sodium alginate solution has a concentration of 0.5 wt % to 3 wt %; and
the calcium chloride solution has a concentration of 0.5 wt % to 4 wt %.

8. The method of claim 3, wherein the acid leaching is conducted for 1 h to 24 h; and
the acid leaching is conducted with an acid, the acid comprising one or two selected from the group consisting of hydrochloric acid and sulfuric acid, and having a concentration of 0.01 mol/L to 0.5 mol/L.

9. The method of claim 3, wherein the aging is conducted for 6 h to 36 h.

10. A method for adsorbing gold ions, comprising:
mixing the biomass-derived carbon particle of claim 1 and a water body to be treated to allow adsorption to obtain an adsorbed biomass-derived carbon particle,
taking out the adsorbed biomass-derived carbon particle, and
separating an elemental gold from the adsorbed biomass-derived carbon particle.

11. The method of claim 10, wherein the biomass-derived carbon particle has a particle size of 0.5 mm to 1 mm.

12. The method of claim 10, wherein the biomass-derived carbon particle is prepared by a process, comprising:
(1) adding a sodium alginate solution dropwise into a calcium chloride solution to obtain a gel ball, aging the gel ball to obtain an aged gel ball, and freeze-drying the aged gel ball to obtain a calcium alginate xerogel ball; and
(2) subjecting the calcium alginate xerogel ball to pre-carbonization, carbonization, and acid leaching sequentially to obtain the biomass-derived carbon particle; wherein
the pre-carbonization and the carbonization each are conducted in an inert atmosphere

13. The method of claim 12, wherein the freeze-drying is conducted at a vacuum degree of 1 Pa to 10 Pa and a cold trap temperature of −75° C. to −60° C. for 12 h to 72 h.

14. The method of claim 12, wherein the pre-carbonization is conducted at a temperature of 250° C. to 350° C. for 1 h to 5 h.

15. The method of claim 12, wherein the carbonization is conducted at a temperature of 400° C. to 900° C. for 1 h to 5 h.

16. The method of claim 12, wherein the sodium alginate solution has a concentration of 0.5 wt % to 3 wt %; and
the calcium chloride solution has a concentration of 0.5 wt % to 4 wt %.

17. The method of claim 12, wherein the acid leaching is conducted for 1 h to 24 h; and
the acid leaching is conducted with an acid, the acid comprising one or two selected from the group consisting of hydrochloric acid and sulfuric acid, and having a concentration of 0.01 mol/L to 0.5 mol/L.

18. The method of claim 12, wherein the aging is conducted for 6 h to 36 h.

19. The method of claim 3, wherein the biomass-derived carbon particle has a particle size of 0.5 mm to 1 mm.
